(19) United States
(12) Patent Application Publication
(10) Pub. No.: US 2026/0228904 A1
(43) Pub. Date: Aug. 6, 2026

(54) SYSTEMS AND METHODS FOR PERFORMING MONOCULAR DEPTH ESTIMATION UNDER VIEWPOINT SHIFTS

(71) Applicant: Verizon Patent and Licensing Inc., Basking Ridge, NJ (US)

(72) Inventors: Aurel PJETRI, Firenze (IT); Stefano CAPRASECCA, Firenze (IT); Leonardo TACCARI, Florence (IT); Henrique Pineiro MONTEAGUDO, Florence (IT); Francesco SAMBO, Florence (IT); Matteo SIMONCINI, Pistoia (IT); Wallace WALTER, Roswell, GA (US); Douglas COIMBRA DE ANDRADE, Conselheiro Lafaiete (BR); Andrew David BAGDANOV, Firenze (IT)

(73) Assignee: Verizon Patent and Licensing Inc., Basking Ridge, NJ (US)

(21) Appl. No.: 19/044,570

(22) Filed: Feb. 3, 2025

(51) Int. Cl. G06T 7/50; G06T 7/73

(52) U.S. Cl. CPC G06T 7/50; G06T 7/75; G06T 2207/10016; G06T 2207/20081; G06T 2207/20224

(57) ABSTRACT

A device may receive base video data and shifted video data, and may select a base video frame from the base video data and a shifted video frame from the shifted video data. The device may estimate a base homography for the base video frame and a shifted homography for the shifted video frame. The device may process the base/shifted video frames, with an object detection model, to detect objects and to generate bounding boxes for the objects, and may utilize the base homography, the shifted homography, and the bounding boxes to calculate ground truth distances to the objects. The device may utilize a depth estimation model to calculate estimated distances to the objects, and may calculate differences between the ground truth and estimated distances. The device may determine, based on the differences, that the depth estimation model needs to be trained and may generate a trained depth estimation model.

### BACKGROUND

Monocular depth estimation is technique used to infer distances of objects from a single camera image. Unlike stereoscopic methods that require multiple cameras to calculate depth, monocular depth estimation relies on visual cues within the image to estimate the three-dimensional distances of objects.

### BRIEF DESCRIPTION OF THE DRAWINGS

FIGS. 1A-1G are diagrams of an example associated with performing monocular depth estimation under viewpoint shifts.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIG. 5 is a flowchart of an example process for performing monocular depth estimation under viewpoint shifts.

### DETAILED DESCRIPTION OF EXAMPLE EMBODIMENTS

The following detailed description of example implementations refers to the accompanying drawings. The same reference numbers in different drawings may identify the same or similar elements.

In the field of autonomous driving and computer vision, perceiving an environment accurately may ensure safety and effective navigation. Monocular depth estimation has become a component in this process by providing a way to infer distances of objects from a single camera image. However, the challenge of accurately estimating depth from a monocular viewpoint is compounded by variability in camera positions and orientations, commonly referred to as viewpoint shifts. These viewpoint shifts may occur due to different vehicle sizes, varied camera installations, and changes in the environment, may impact performances of depth estimation models. Despite the known issues caused by viewpoint shifts, datasets used for training and testing depth estimation models often lack a variety of viewpoints. This lack of diversity in camera viewpoints does not reflect the real-world scenarios where cameras are installed in various positions and orientations, leading to potential inaccuracies and limitations in the performance of depth estimation models. Furthermore, traditional methods for evaluating depth estimation involve using expensive LiDAR sensors, which are not universally available and require complex post-processing procedures.

Thus, current techniques for performing monocular depth estimation consume computing resources (e.g., processing resources, memory resources, communication resources, and/or the like), networking resources, and/or other resources associated with utilizing expensive sensors and complex post-processing procedures to perform depth estimations, failing to account for viewpoint shifts when training depth estimation models, generating inaccurate depth estimation models based on improperly training the depth estimation models, generating inaccurate depth estimates with the inaccurate depth estimation models, and/or the like.

Some implementations described herein provide a video system that performs monocular depth estimation under viewpoint shifts. For example, the video system may receive base video data that includes base video frames and shifted video data that includes shifted video frames, and may select a base video frame from the base video data and a shifted video frame from the shifted video data. The video system may estimate a base homography that maps ground points in the base video frame to a target plane with a metric reference system, and may estimate a shifted homography that maps ground points in the shifted video frame to the target plane with the metric reference system. The video system may process the base video frame and the shifted video frame, with an object detection model, to detect objects in the base video frame and the shifted video frame and to generate bounding boxes for the objects, and may utilize the base homography, the shifted homography, and the bounding boxes to calculate ground truth distances to the objects of the base video frame and the shifted video frame. The video system may utilize a depth estimation model to calculate estimated distances to the objects, and may calculate differences between the ground truth distances and the estimated distances. The video system may determine, based on the differences, that the depth estimation model needs to be trained and may generate a trained depth estimation model based on the determination, and may perform one or more actions based on the trained depth estimation model.

In this way, the video system performs monocular depth estimation under viewpoint shifts. For example, the video system may accurately train a depth estimation model across a variety of camera viewpoints so that the depth estimation model may be utilized in real-world applications where cameras can be installed in multiple positions and orientations. By utilizing homography and object detection, the video system may reduce reliance on expensive sensors and complex post-processing. The video system enables creation of depth estimation models that are more robust to viewpoint shifts, and that enhance technical reliability and operational safety of autonomous driving systems and other computer vision applications. The video system may also facilitate development of applications, such as tailgating detection, by providing accurate distance measurements using cost-effective mechanisms. Thus, the video system may conserve computing resources, networking resources, and/or other resources that would have otherwise been consumed by utilizing expensive sensors and complex post-processing procedures to perform depth estimations, failing to account for viewpoint shifts when training depth estimation models, generating inaccurate depth estimation models based on improperly training the depth estimation models, generating inaccurate depth estimates with the inaccurate depth estimation models, and/or the like.

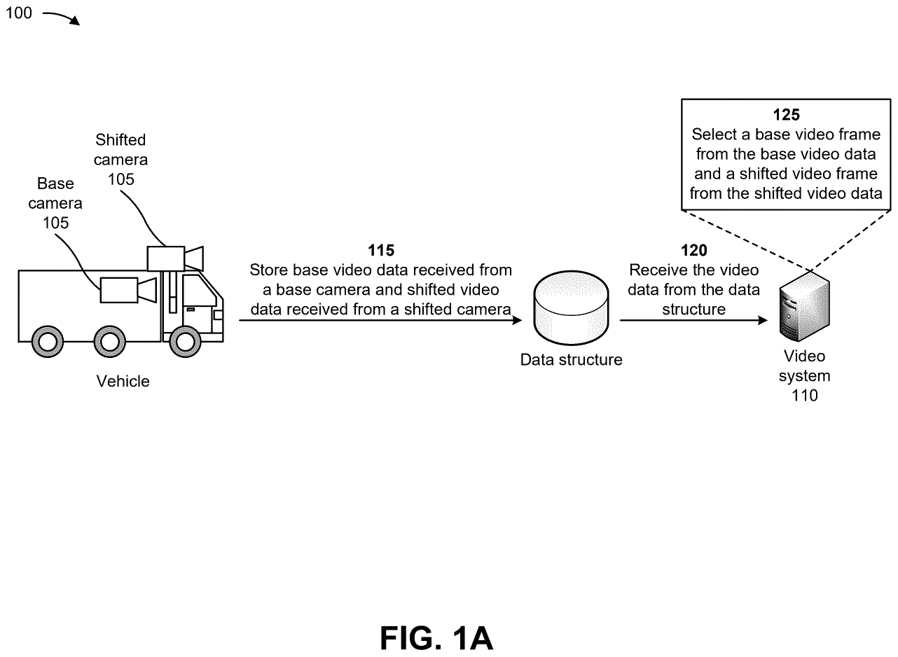

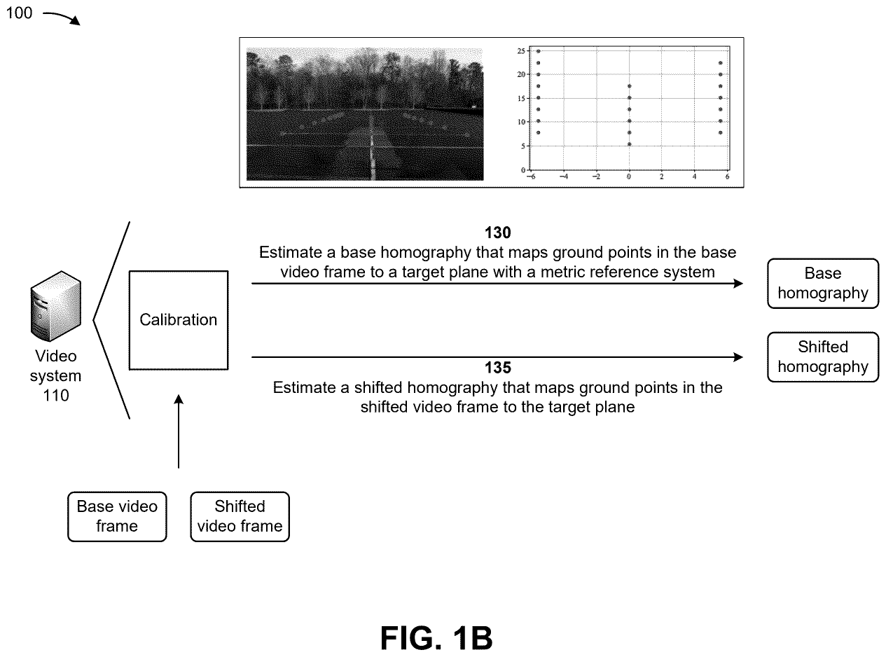

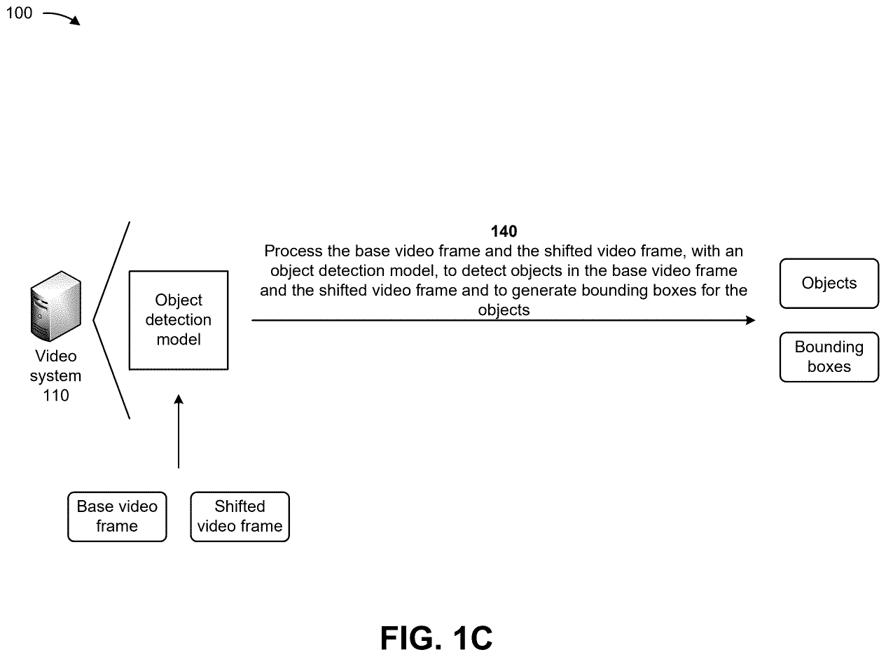

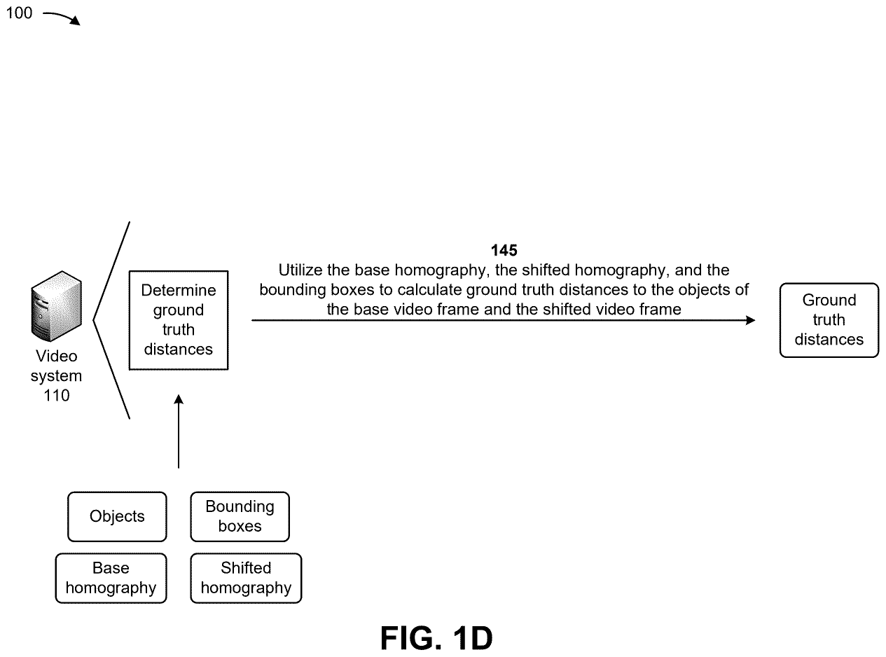

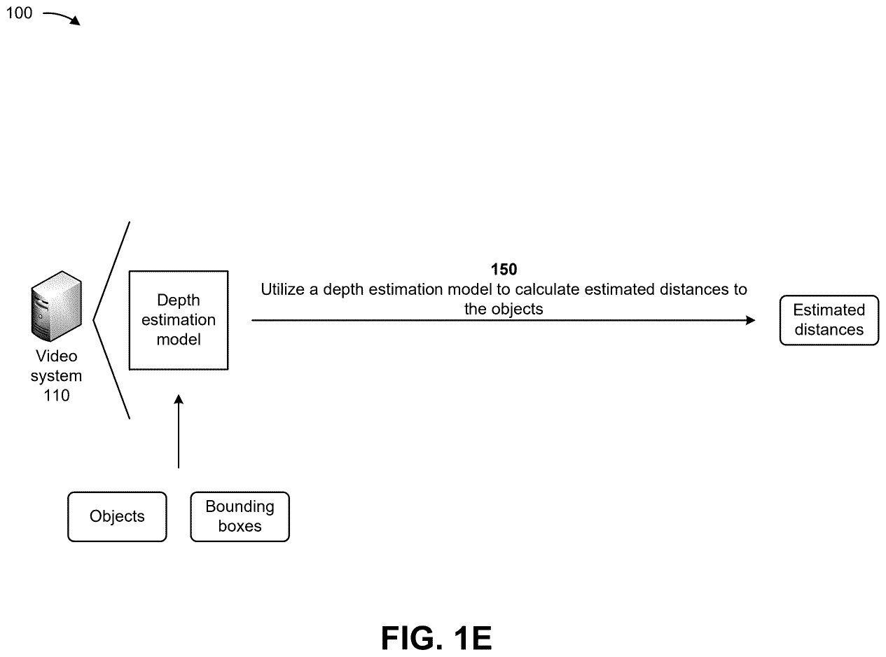

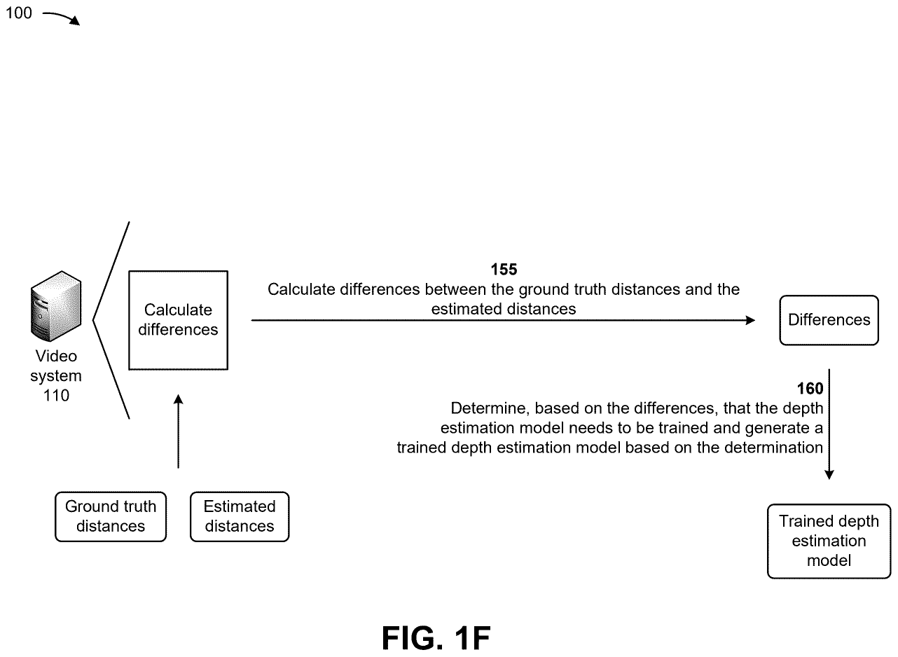

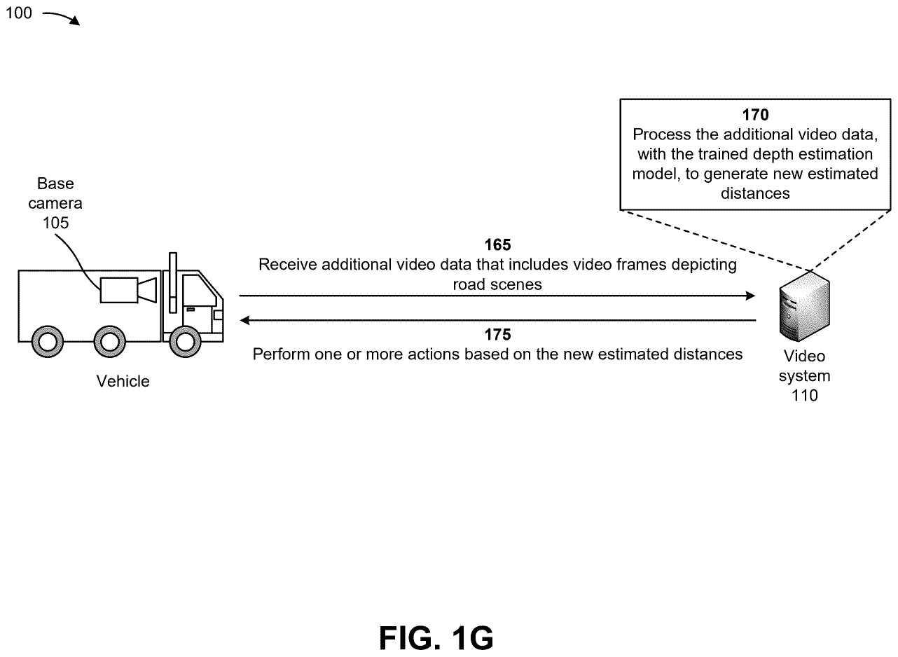

FIGS. 1A-1G are diagrams of an example 100 associated with performing monocular depth estimation under viewpoint shifts. As shown in FIGS. 1A-1G, the example 100 includes a base camera 105, a shifted camera 105, and a data structure associated with a vehicle and a video system 110. The base camera 105 and the shifted camera 105 may capture video of objects (e.g., packages, cargo, pedestrians, traffic signs, traffic signals, road markers, a driver, animals, and/or the like) associated with the vehicle. The base camera 105 and/or the shifted camera 105 may include a dashcam of the vehicle, a forward-facing camera of the vehicle, a side camera of the vehicle, a rear camera of the vehicle, and/or the like. The data structure may include a database, a table, a list, and/or the like that stores training data. The video system 110 may include a system that performs monocular depth estimation under viewpoint shifts. Further details of the base camera 105, the shifted camera 105, the data structure, the vehicle, and the video system 110 are provided elsewhere herein. Although implementations described herein depict a single vehicle, in some implementations, the video system 110 may be associated with multiple vehicles.

As shown by FIG. 1A, and by reference number 115, the base camera 105 may store, in the data structure, base video data that includes video frames depicting road scenes associated with the vehicle, and the shifted camera 105 may store, in the data structure, shifted video data that includes video frames depicting road scenes associated with the vehicle. For example, the base camera 105 and the shifted camera 105 may be arranged to provide a measure of the effect of different viewpoint shifts on monocular depth estimation models. Each of the cameras 105 may include identical dashcams installed on a windshield of the vehicle. The base camera 105 may be fixed close to a rear-view mirror at a specific height and with a specific orientation (e.g., 0° roll, 0° yaw, and −4° pitch). The shifted camera 105 may be utilized to simulate different viewpoint shifts and may be moved to different combinations of heights and orientations. Pitch and yaw angles for each viewpoint may be measured by labeling a horizontal vanishing point from straight lines on a road (vᵤ, vᵥ) and computing an angle given a focal length (fₓ, f_{y}) of the camera and a principal point (cᵤ, cᵥ):

$$pitch = \frac{180}{π} artcan ( \frac{{c}_{v} - {v}_{v}}{{f}_{y}} ) , and \qquad ( 1 )$$

$$yaw = \frac{180}{π} artcan ( \frac{{c}_{u} - {v}_{u}}{{f}_{x}} ) . \qquad ( 2 )$$

A number of different viewpoints may be collected by the shifted camera 105. In some implementations, since the base camera 105 and the shifted camera 105 may record at an average of thirty frames per second and with a 150° diagonal field of view, the video data may be down-sampled to reduce a quantity of video frames in the video data.

In some implementations, the base camera 105 associated with the vehicle may continuously capture the base video data and the shifted camera 105 may continuously capture the shifted video data. The base camera 105 may provide the base video data to the data structure (e.g., a table, a list, a database, and/or the like), the shifted camera 105 may provide the shifted video data to the data structure, and the data structure may store the base video data and the shifted video data. In some implementations, the base camera 105 may periodically store the base video data in the data structure, may continuously store the base video data in the data structure, may store the base video data in the data structure based on a request, and/or the like. In some implementations, the shifted camera 105 may periodically store the shifted video data in the data structure, may continuously store the shifted video data in the data structure, may store the shifted video data in the data structure based on a request, and/or the like.

As further shown in FIG. 1A, and by reference number 120, the video system 110 may receive the base video data and the shifted video data from the data structure. For example, the video system 110 may continuously receive the base video data and the shifted video data from the data structure, may periodically receive the base video data and the shifted video data from the data structure, may receive the base video data and the shifted video data from the data structure based on requesting the base video data and the shifted video data, and/or the like. In some implementations, the video system 110 may continuously (e.g., in near-real-time) or periodically receive the base video data directly from the base camera 105, may continuously (e.g., in near-real-time) or periodically receive the shifted video data from the shifted camera 105, and/or the like.

As further shown in FIG. 1A, and by reference number 125, the video system 110 may select a base video frame from the base video data and a shifted video frame from the shifted video data. For example, the video system 110 may analyze the base video data and the shifted video data to identify video frames that correspond to the same time stamp or the same scene. The video system 110 may then pair these video frames (e.g., the selected base video frame and the selected shifted video frame) for further processing, which may ensure that the video frames selected from the base video data and the shifted video data depict the same or similar objects and scenes for accurate comparison and analysis. In some implementations, the video system 110 may utilize a non-synchronization mechanism that provides potential shifts by a variable quantity of video frames between the base video data and the shifted video data due to a lack of synchronization. For example, without a synchronization mechanism, the base camera 105 and the shifted camera 105 may not capture video frames at precisely the same moment, resulting in slight temporal discrepancies that must be accounted for during analysis.

As shown in FIG. 1B, and by reference number 130, a base homography may be estimated that maps ground points in the base video frame to a target plane with a metric reference system. The video system 110 may estimate the base homography or the base homography may be manually estimated. For example, calibration data may be utilized to identify reference points on the ground in the base video frame and these reference points may be mapped to corresponding points in a target plane defined with a metric reference system. The base homography estimation process may include calculating a transformation matrix that allows ground points in the base video frame to be accurately projected onto the target plane. The transformation matrix may ensure that the coordinates of the ground points are consistently projected according to the metric system of the target plane. The calibration data may aid in reducing projection errors by providing precise camera alignment and orientation details.

To implement the homography transformations, the video system 110 may utilize computer vision libraries. The base homography matrix may be calculated by identifying four or more corresponding points between the base video frame and the target plane using a direct linear transformation (DLT) model. The coordinates of these points may be detected using feature matching models. The same process is repeated to calculate the shifted homography matrix for the shifted video frame. These homography matrices may be applied to map any point in the base or shifted video frames to the target plane coordinates using matrix multiplication.

In some implementations, the video system 110 may utilize the ground points with a least-squares scheme to estimate the base homography. In some implementations, the video system 110 may select reference ground points in the base video frame and may measure distances from the ground points to the base camera 105 to construct the target plane with the metric reference system centered in the base camera 105. Thus, for any point X=[x, y]^{T}, a distance of the point to the base camera 105 may be computed by \sqrt{x²+y²+h²}, where h is a height of the base camera 105. This enables the video system 110 to estimate the base homography that maps points in the base video frame to points on the target plane (T), and therefore to associate a metric distance to any point in the base video frame. For example, for a point on the base video frame (x=[u, v]^{T}), the video system 110 may project the point to a point X in the target plane as follows:

$${[ X , Y , W ]}^{T} = H \cdot {[ u , v , 1 ]}^{T} \to X = {[ X / W , Y / W ]}^{T} = {[ x , y ]}^{T} . \qquad ( 3 )$$

As further shown in FIG. 1B, and by reference number 135, the video system 110 may estimate a shifted homography that maps ground points in the shifted video frame to the target plane. For example, after determining the base homography, the video system 110 may use corresponding points between the base video frame and the shifted video frame to compute the shifted homography. The shifted homography may enable the video system 110 to account for the different viewpoints captured by the shifted camera 105 and may ensure that ground points in the shifted video frame can also be projected onto the target plane accurately. The corresponding points may include naturally occurring features or specifically placed markers that are visible in the base video frame and the shifted video frame. This step may involve an iterative model to refine the mapping based on additional frames or data points. Additionally, or alternatively, the video system 110 may compute the shifted homography by using shared reference points between the base video frame and the shifted video frame to adjust for different viewpoints. Shared reference points help in aligning the frames accurately by compensating for any deviations caused by the change in viewpoint.

As shown in FIG. 1C, and by reference number 140, the video system 110 may process the base video frame and the shifted video frame, with an object detection model, to detect objects in the base video frame and the shifted video frame and to generate bounding boxes for the objects. For example, the video system 110 may utilize an object detection model to analyze the base video frame and the shifted video frame and to identify objects (e.g., cars, trucks, buses, motorcycles, pedestrians, bicycles, and/or the like) that are present in the base video frame and the shifted video frame. The object detection model may then generate bounding boxes around the detected objects. The bounding boxes may represent spatial coordinates within the base video frame and the shifted video frame that encompass the detected objects. The generation of the bounding boxes may include the video system 110 identifying top-left and bottom-right coordinates of each object within the base video frame and the shifted video frame, and creating a rectangular boundary around each detected object. The bounding boxes may provide a means to isolate and focus on specific objects within the base video frame and the shifted video frame for further analysis and processing.

In some implementations, given a bounding box with coordinates (x₁, y₁) and (x₂, y₂), and considering only objects that lie on the ground, the video system 110 may define a distance as that of a center of a lower side of a box \hat{X}=((x₂−x₂)/2, y₂). By projecting the point using Equation (3), the video system 110 may associate a metric distance to each object and may utilize the metric distance as a ground truth for evaluation of a depth estimation model, as describe below.

In some implementations, the video system 110 may utilize an object recognition model to identify objects within the base video frame and the shifted video frame and to generate bounding boxes around the objects. For example, the object recognition model may be trained on various classes of objects and may identify the presence of such objects in the base video frame and the shifted video frame, subsequently generating the corresponding bounding boxes. Additionally, or alternatively, the video system 110 may utilize a deep learning model to detect objects in the base video frame and the shifted video frame and to create bounding boxes that delineate each detected object. A deep learning model may improve detection accuracy by leveraging large datasets and extensive training processes. Additionally, or alternatively, the video system 110 may utilize a convolutional neural network (CNN) model to analyze the base video frame and the shifted video frame, detect objects in the base video frame and the shifted video frame, and generate bounding boxes around the detected objects. For example, a CNN model may include multiple layers that process the base video frame and the shifted video frame by extracting and classifying features to accurately detect objects and draw bounding boxes around them.

Additionally, or alternatively, the video system 110 may utilize a region-based convolutional neural network (R-CNN) model to detect objects within the base video frame and the shifted video frame, and generate bounding boxes for each detected object. An R-CNN model may provide precise localization by proposing regions of interest and performing object detection within those regions. Additionally, or alternatively, the video system 110 may utilize a machine learning model to detect various objects in the base video frame and the shifted video frame and to generate bounding boxes to highlight these objects. A machine learning model may be tailored to specific object detection tasks by training on relevant datasets. Additionally, or alternatively, the video system 110 may utilize a YOLO (You Only Look Once) model to process the base video frame and the shifted video frame, identify objects in the base video frame and the shifted video frame, and create bounding boxes around the objects. The YOLO model may provide real-time object detection by processing the entire base video frame and the shifted video frame in one pass.

Additionally, or alternatively, the video system 110 may utilize a Faster R-CNN model to detect and generate bounding boxes for objects present in the base video frame and the shifted video frame. The Faster R-CNN model may quickly propose regions of interest and perform object detection with high accuracy. Additionally, or alternatively, the video system 110 may utilize a Single Shot MultiBox Detector (SSD) model to process the base video frame and the shifted video frame, detect objects in the base video frame and the shifted video frame, and generate bounding boxes indicating the locations of these objects. The SSD model may provide real-time detection performance by using a single forward pass of the network for both localization and classification tasks. Additionally, or alternatively, the video system 110 may utilize an object segmentation model to detect objects within the base video frame and the shifted video frame and to generate bounding boxes that encompass these objects. An object segmentation model may provide pixel-level accuracy in detecting object boundaries. Additionally, or alternatively, the video system 110 may utilize an instance segmentation model to identify and generate bounding boxes for objects in the base video frame and the shifted video frame. An instance segmentation model may distinguish between multiple instances of the same object class and provide separate bounding boxes for each instance.

As shown in FIG. 1D, and by reference number 145, the video system 110 may utilize the base homography, the shifted homography, and the bounding boxes to calculate ground truth distances to the objects of the base video frame and the shifted video frame. For example, the video system 110 may use the base homography to map the ground points in the base video frame to the target plane with the metric reference system, and the shifted homography to map the ground points in the shifted video frame to the same target plane. The bounding boxes, generated from processing the base video frame and the shifted video frame with the object detection model, may provide spatial coordinates of detected objects. By projecting the lower center point of each bounding box to the target plane using the homographies, the video system 110 may determine metric or ground truths distances to the objects. In some implementations, the video system 110 may filter out bounding boxes with low confidence levels or bounding boxes that do not align with reference points to improve the accuracy of the ground truth distance calculations. For example, to exclude problematic cases, the video system 110 may filter out bounding boxes with a confidence level less than a threshold (e.g., 0.5), bounding boxes with lower sides above a vanishing point of the base camera 105. Furthermore, the video system 110 may remove occluded objects by detecting overlapping bounding boxes and only retaining the lowest objects ones in the base video frame and the shifted video frame. Finally, the video system 110 may filter out small objects with specific area thresholds for each class (e.g., vehicles, people, bicycles, motorcycles, and/or the like).

In some implementations, the video system 110 may employ the base homography and the shifted homography to project ground points from the base video frame and the shifted video frame onto a target plane, determining metric distances to objects. For example, the projection may enable the video system 110 to accurately align multiple viewpoints to a common reference for precise distance calculations. Additionally, or alternatively, by associating the lower center point of each bounding box with the homographies, the video system 110 may compute the ground truth distances to detected objects. The association may enable the video system 110 to identify precise locations of objects relative to a viewpoint of the base camera 105. Additionally, or alternatively, to maintain and refine the accuracy of the homographies, the video system 110 may continuously update the homographies with new data points, improving the accuracy of ground truth distance computations over time. This continuous refinement may enable the video system 110 to adapt to changes and variations in the video environment, ensuring consistent performance of the video system 110.

As shown in FIG. 1E, and by reference number 150, the video system 110 may utilize a depth estimation model to calculate estimated distances to the objects. For example, the video system 110 may utilize the depth estimation model (e.g., a monocular depth estimation model) to analyze the base video frame and estimate a distance for each pixel of the base video frame. The depth estimation model may calculate the estimated distances from the base camera 105 to the pixels of the base video frame based on depth cues and base video frame data. Depth cues may include features such as object size, texture gradient, and relative motion between video frames. The estimated distances may represent the distance values for the pixels of the base video frame as determined by the depth estimation model. Thus, the output of the depth estimation model is a depth map (or grid) of the same size as the base video frame with a distance value for each pixel of the base video frame. The video system 110 may project bounding box coordinates of the detected objects onto the depth map generated by the depth estimation model, thereby enabling the calculation of the estimated distances to the objects within the field of view of the base camera 105.

To measure the performance of the depth estimation model, video system 110 may utilize the bounding boxes and the depth estimation model to infer dense distances of the points within the bounding boxes. The video system 110 may select a percentile (β) from the estimated distances and may utilize the percentile as an inferred object distance. Moreover, to account for inaccuracies, the video system 110 may resize the bounding boxes to a certain fraction (α) of the original dimensions before collecting inferred depths. The percentile and the fraction may be treated as hyperparameters that are selected by the video system 110.

As shown in FIG. 1F, and by reference number 155, the video system 110 may calculate differences between the ground truth distances and the estimated distances. For example, the video system 110 may compare the ground truth distances with corresponding estimated distances to determine the differences between the ground truth distances and the estimated distances. In some implementations, each of the differences may be calculated as an absolute relative error (abs_rel), as follows:

$$abs\_rel = 100 \cdot \frac{1}{N} {\sum }_{i = 0}^{N} \frac{\vert {x}_{g t}^{i} - {x}_{e s t}^{i} \vert}{{x}_{g t}^{i}} , \qquad ( 4 )$$

where

$${x}_{gt}^{i}$$

corresponds to a ground truth distance and

$${x}_{est}^{i}$$

corresponds to an estimated distance.

As further shown in FIG. 1F, and by reference number 160, the video system 110 may determine, based on the differences, that the depth estimation model needs to be trained and may generate a trained depth estimation model based on the determination. For example, the video system 110 update parameters of the depth estimation model through a learning model, such as a gradient descent model or another optimization technique. The video system 110 may adjust the parameters of the depth estimation model to minimize an overall error, thereby improving the accuracy of the depth estimation model in estimating distances. The video system 110 may iterate the training process over many video frames and possibly different road scenes to generalize well across various conditions and viewpoints. The video system 110 may further refine the depth estimation model by continuously receiving new video data, processing the new video data, and incorporating new error feedback into the depth estimation model. The video system 110 may also validate a performance of the depth estimation model by using datasets with known ground truth distances to ensure accuracy and robustness. This iterative training process may enable the depth estimation model to learn to better predict object distances from monocular camera footage, even when there are changes in the viewpoint.

In some implementations, the video system 110 may receive additional data associated with the base video data and the shifted video data. For example, the additional data may include global positioning system (GPS) data associated with the base camera 105, the shifted camera 105, and the vehicle, and accelerometer data associated with the base camera 105, the shifted camera 105, and the vehicle. The GPS data may provide precise location information, and the accelerometer data may offer insights into motion dynamics of the vehicle. In some implementations, the video system 110 may utilize the GPS data and/or the accelerometer data to further train and enhance the depth estimation model and improve overall accuracy of the depth estimation model. To incorporate the GPS data and the accelerometer data, the video system 110 may align timestamps of the video frames with the corresponding timestamps of the GPS data and the accelerometer data. The GPS data may provide latitude, longitude, and altitude, which are converted into a local coordinate system relative to a starting point. The accelerometer data may provide acceleration in three axes, and may be integrated over time to estimate velocity and displacement. These additional features may be concatenated with the image features extracted from the video frames, forming a comprehensive feature vector for each frame. This enriched data is then fed into the depth estimation model during training, allowing the depth estimation model to learn the correlation between motion dynamics and depth estimation.

In some implementations, the video system 110 may perform one or more actions based on the trained model. For example, performing the one or more actions may include the video system 110 implementing the trained depth estimation model in a camera associated with a vehicle. The video system 110 may store the trained depth estimation model in the base camera 105 of the vehicle so that the base camera 105 may accurately calculate distances to objects encountered by the vehicle in real time. This may enable the vehicle and/or a driver of the vehicle to operate the vehicle more safely. In this way, the video system 110 conserves computing resources, networking resources, and/or other resources that would have otherwise been consumed by utilizing expensive sensors and complex post-processing procedures to perform depth estimations.

In some implementations, performing the one or more actions may include the video system 110 implementing the trained depth estimation model in a vehicle. For example, the video system 110 may store the trained depth estimation model in the vehicle so that the vehicle may accurately calculate distances to objects encountered by the vehicle in real time. This may enable the vehicle and/or a driver of the vehicle to operate the vehicle more safely. In this way, the video system 110 conserves computing resources, networking resources, and/or other resources that would have otherwise been consumed by utilizing expensive sensors and complex post-processing procedures to perform depth estimations.

In some implementations, performing the one or more actions may include the video system 110 utilizing the trained depth estimation model to provide an alert to a vehicle. For example, the video system 110 may receive video data from the base camera 105 in real time, and may utilize the trained depth estimation model to determine that the vehicle is within an unsafe distance from an object. The video system 110 may generate an alert indicating the unsafe distance, and may provide the alert to the vehicle. The vehicle may provide the alert (e.g., a visual alert, an audible alert, and/or the like) to a driver of the vehicle. In this way, the video system 110 conserves computing resources, networking resources, and/or other resources that would have otherwise been consumed by generating inaccurate depth estimates with the inaccurate depth estimation models.

In some implementations, performing the one or more actions may include the video system 110 utilizing the trained depth estimation model to cause a vehicle to perform a maneuver. For example, the video system 110 may receive video data from the base camera 105 in real time, and may utilize the trained depth estimation model to determine that the vehicle is within an unsafe distance from an object. The video system 110 may generate instructions for a maneuver to eliminate the unsafe distance, and may provide the instructions to the vehicle. The vehicle may perform the maneuver based on the instructions and to eliminate the unsafe distance. In this way, the video system 110 conserves computing resources, networking resources, and/or other resources that would have otherwise been consumed by generating inaccurate depth estimates with the inaccurate depth estimation models.

In some implementations, performing the one or more actions may include the video system 110 utilizing the trained depth estimation model to provide an alert to a fleet manager of a vehicle. For example, the video system 110 may receive video data from the base camera 105 in real time, and may utilize the trained depth estimation model to determine that the vehicle is performing an unsafe maneuver (e.g., tailgating). The video system 110 may generate an alert indicating the unsafe maneuver, and may provide the alert to the fleet manager of the vehicle. The fleet manager may take appropriate action against the driver of the vehicle based on the alert. In this way, the video system 110 conserves computing resources, networking resources, and/or other resources that would have otherwise been consumed by handling traffic accidents caused by the vehicle, handling insurance issues associated with drivers, and/or the like.

In some implementations, performing the one or more actions may include the video system 110 utilizing the trained depth estimation model to schedule a driver of a vehicle for training. For example, the video system 110 may receive video data from the base camera 105 in real time, and may utilize the trained depth estimation model to determine that the vehicle is performing an unsafe maneuver (e.g., tailgating). The video system 110 may schedule the driver of the vehicle for training associated with safe driving tactics so that the driver learns to not tailgate. In this way, the video system 110 conserves computing resources, networking resources, and/or other resources that would have otherwise been consumed by handling traffic accidents caused by the vehicle, handling insurance issues associated with drivers, and/or the like.

As shown in FIG. 1G, and by reference number 165, the video system 110 may receive additional video data that includes video frames depicting road scenes. For example, the video system 110 may receive, from a camera 105 and/or a vehicle, additional video data that includes video frames depicting road scenes (e.g., with objects) encountered by the vehicle. In some implementations, the video system 110 may receive the additional video data in real time or near-real-time so that the video system 110 may analyze the additional video data in real time or near-real-time.

As further shown in FIG. 1G, and by reference number 170, the video system 110 may process the additional video data, with the trained depth estimation model, to generate new estimated distances. For example, the video system 110 may utilize the trained depth estimation model to analyze the additional video data and identify spatial coordinates of bounding boxes generated for detected objects in the additional video data. The trained depth estimation model may then calculate the new estimated distances to the objects based on depth cues and additional video data. The new estimated distances may represent the predicted distances to the objects as determined by the trained depth estimation model.

As further shown in FIG. 1G, and by reference number 175, the video system 110 may perform one or more actions based on the new estimated distances. For example, the video system 110 may determine that the depth estimation model needs to be retrained based on the new estimated distances, and may retrain the depth estimation model based on the determination. Accordingly, the video system 110 may conserve computing resources associated with generating inaccurate depth estimation models based on improperly training the depth estimation models.

In some implementations, performing the one or more actions may include the video system 110 providing an alert to a vehicle based on the new estimated distances. For example, the video system 110 may utilize the new estimated distances to determine that the vehicle is within an unsafe distance from an object. The video system 110 may generate an alert indicating the unsafe distance, and may provide the alert to the vehicle. The vehicle may provide the alert (e.g., a visual alert, an audible alert, and/or the like) to a driver of the vehicle. In this way, the video system 110 conserves computing resources, networking resources, and/or other resources that would have otherwise been consumed by generating inaccurate depth estimates with the inaccurate depth estimation models.

In some implementations, performing the one or more actions may include the video system 110 causing a vehicle to perform a maneuver based on the new estimated distances. For example, the video system 110 may utilize the new estimated distances to determine that the vehicle is within an unsafe distance from an object. The video system 110 may generate instructions for a maneuver to eliminate the unsafe distance, and may provide the instructions to the vehicle. The vehicle may perform the maneuver based on the instructions and to eliminate the unsafe distance. In this way, the video system 110 conserves computing resources, networking resources, and/or other resources that would have otherwise been consumed by generating inaccurate depth estimates with the inaccurate depth estimation models.

In some implementations, performing the one or more actions may include the video system 110 providing an alert to a fleet manager of a vehicle based on the new estimated distances. For example, the video system 110 may utilize the new estimated distances to determine that the vehicle is performing an unsafe maneuver (e.g., tailgating). The video system 110 may generate an alert indicating the unsafe maneuver, and may provide the alert to the fleet manager of the vehicle. The fleet manager may take appropriate action against the driver of the vehicle based on the alert. In this way, the video system 110 conserves computing resources, networking resources, and/or other resources that would have otherwise been consumed by handling traffic accidents caused by the vehicle, handling insurance issues associated with drivers, and/or the like.

In some implementations, performing the one or more actions may include the video system 110 scheduling a driver of a vehicle for training based on the new estimated distances. For example, the video system 110 may utilize the new estimated distances to determine that the vehicle is performing an unsafe maneuver (e.g., tailgating). The video system 110 may schedule the driver of the vehicle for training associated with safe driving tactics so that the driver learns to not tailgate. In this way, the video system 110 conserves computing resources, networking resources, and/or other resources that would have otherwise been consumed by handling traffic accidents caused by the vehicle, handling insurance issues associated with drivers, and/or the like.

In some implementations, the depth estimation model may include a tailgating model (e.g., a deep learning model) that determines whether a vehicle is tailgating one or more other vehicles. The video system 110 may utilize the implementations described herein (e.g., video data, GPS data, accelerometer data, object detection, and ground truth distances) to train and test the tailgating model. The video system 110 may train the tailgating model to classify tailgating scenarios in an end-to-end manner (e.g., directly from short video frame sequences without distance or object information). Given the variety of viewpoints and scenarios, the tailgating model may be more resilient to new unseen viewpoints, and may perform accurately for different viewpoints on which the tailgating model has been trained.

In this way, the video system 110 performs monocular depth estimation under viewpoint shifts. For example, the video system 110 may accurately train a depth estimation model across a variety of camera viewpoints so that the depth estimation model may be utilized in real-world applications where cameras 105 can be installed in multiple positions and orientations. By utilizing homography and object detection, the video system 110 may reduce reliance on expensive sensors and complex post-processing. The video system 110 enables creation of depth estimation models that are more robust to viewpoint shifts, and that enhance technical reliability and operational safety of autonomous driving systems and other computer vision applications. The video system 110 may also facilitate development of applications, such as tailgating detection, by providing accurate distance measurements using cost-effective mechanisms. Thus, the video system 110 may conserve computing resources, networking resources, and/or other resources that would have otherwise been consumed by utilizing expensive sensors and complex post-processing procedures to perform depth estimations, failing to account for viewpoint shifts when training depth estimation models, generating inaccurate depth estimation models based on improperly training the depth estimation models, generating inaccurate depth estimates with the inaccurate depth estimation models, and/or the like.

As indicated above, FIGS. 1A-1G are provided as an example. Other examples may differ from what is described with regard to FIGS. 1A-1G. The number and arrangement of devices shown in FIGS. 1A-1G are provided as an example. In practice, there may be additional devices, fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

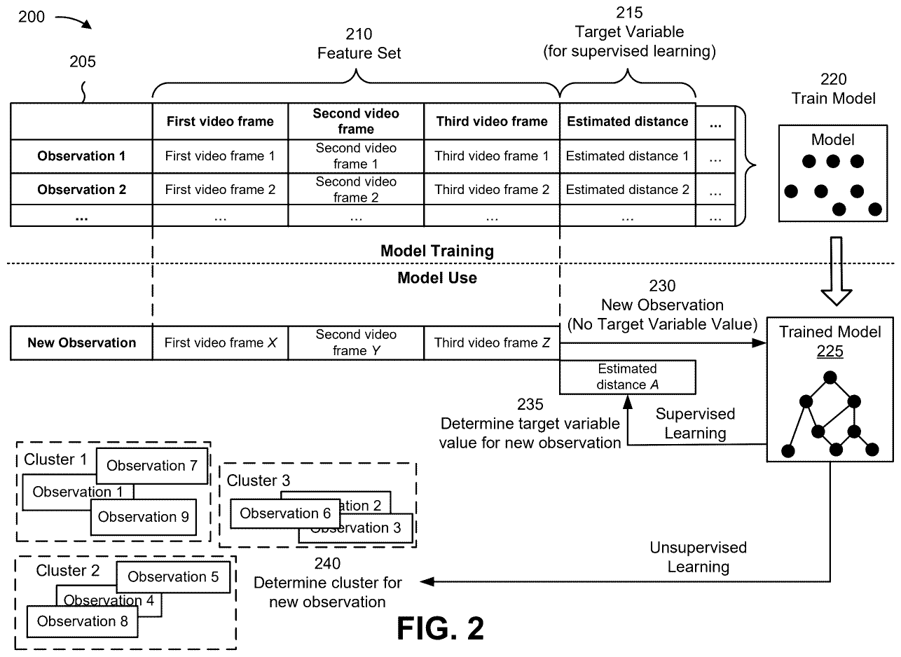

FIG. 2 is a diagram illustrating an example 200 of training and using a machine learning model for performing monocular depth estimation. The machine learning model training and usage described herein may be performed using a machine learning system. The machine learning system may include or may be included in a computing device, a server, a cloud computing environment, and/or the like, such as the video system 110 described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the video system 110, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the video system 110. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of a first video frame, a second feature of a second video frame, a third feature of a third video frame, and so on. As shown, for a first observation, the first feature may have a value of a first video frame 1, the second feature may have a value of a second video frame 1, the third feature may have a value of a third video frame 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable may be entitled “estimated distance” and may include a value of estimated distance 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of a first video frame X, a second feature of a second video frame Y, a third feature of a third video frame Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of estimated distance A for the target variable of the stability for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a first video frame cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a second video frame cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to perform monocular depth estimation. The machine learning system enables recognition and/or identification of tens, hundreds, thousands, or millions of features and/or feature values for tens, hundreds, thousands, or millions of observations, thereby increasing accuracy and consistency and reducing delay associated with performing monocular depth estimation relative to requiring computing resources to be allocated for tens, hundreds, or thousands of operators to manually perform monocular depth estimation.

As indicated above, FIG. 2 is provided as an example. Other examples may differ from what is described in connection with FIG. 2.

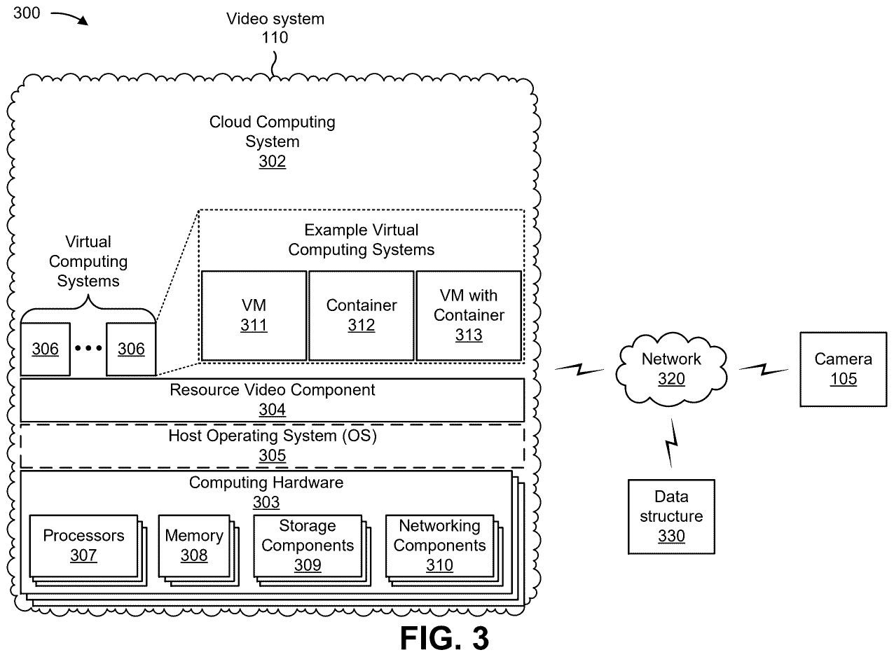

FIG. 3 is a diagram of an example environment 300 in which systems and/or methods described herein may be implemented. As shown in FIG. 3, the environment 300 may include the video system 110, which may include one or more elements of and/or may execute within a cloud computing system 302. The cloud computing system 302 may include one or more elements 303-313, as described in more detail below. As further shown in FIG. 3, the environment 300 may include the base camera 105 and the shifted camera 105 (e.g., each of which is also referred to herein as “camera 105”), a network 320, and/or a data structure 330. Devices and/or elements of the environment 300 may interconnect via wired connections and/or wireless connections.

The camera 105 may include one or more devices capable of receiving, generating, storing, processing, providing, and/or routing information, as described elsewhere herein. The camera 105 may include a communication device and/or a computing device. For example, the camera 105 may include an optical instrument that captures videos (e.g., images and audio). The camera 105 may feed real-time video directly to a screen or a computing device for immediate observation, may record the captured video (e.g., images and audio) to a storage device for archiving or further processing, and/or the like. In some implementations, the camera 105 may include a dashcam of a vehicle, a forward-facing camera of a vehicle, a side camera of a vehicle, a rear camera of a vehicle, and/or the like.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of the computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using the computing hardware 303. As shown, the virtual computing system 306 may include a virtual machine 311, a container 312, or a hybrid environment 313 that includes a virtual machine and a container, among other examples. The virtual computing system 306 may execute one or more applications using a file system that includes binary files, software libraries, and/or other resources required to execute applications on a guest operating system (e.g., within the virtual computing system 306) or the host operating system 305.

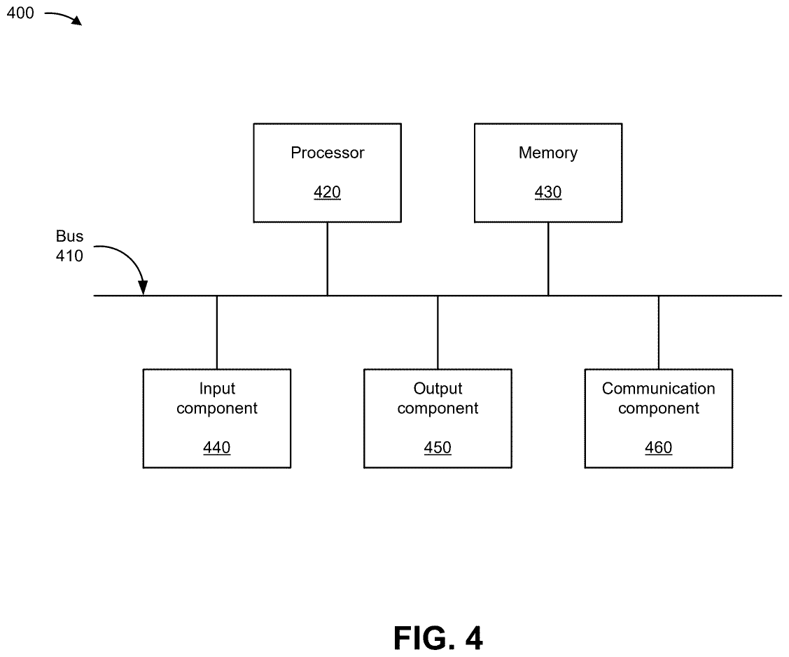

Although the video system 110 may include one or more elements 303-313 of the cloud computing system 302, may execute within the cloud computing system 302, and/or may be hosted within the cloud computing system 302, in some implementations, the video system 110 may not be cloud-based (e.g., may be implemented outside of a cloud computing system) or may be partially cloud-based. For example, the video system 110 may include one or more devices that are not part of the cloud computing system 302, such as a device 400 of FIG. 4, which may include a standalone server or another type of computing device. The video system 110 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The data structure 330 may include one or more devices capable of receiving, generating, storing, processing, and/or providing information, as described elsewhere herein. The data structure 330 may include a communication device and/or a computing device. For example, the data structure 330 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data structure 330 may communicate with one or more other devices of the environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the base camera 105, the shifted camera 105, the video system 110, and/or the data structure 330. In some implementations, the base camera 105, the shifted camera 105, the video system 110, and/or the data structure 330 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

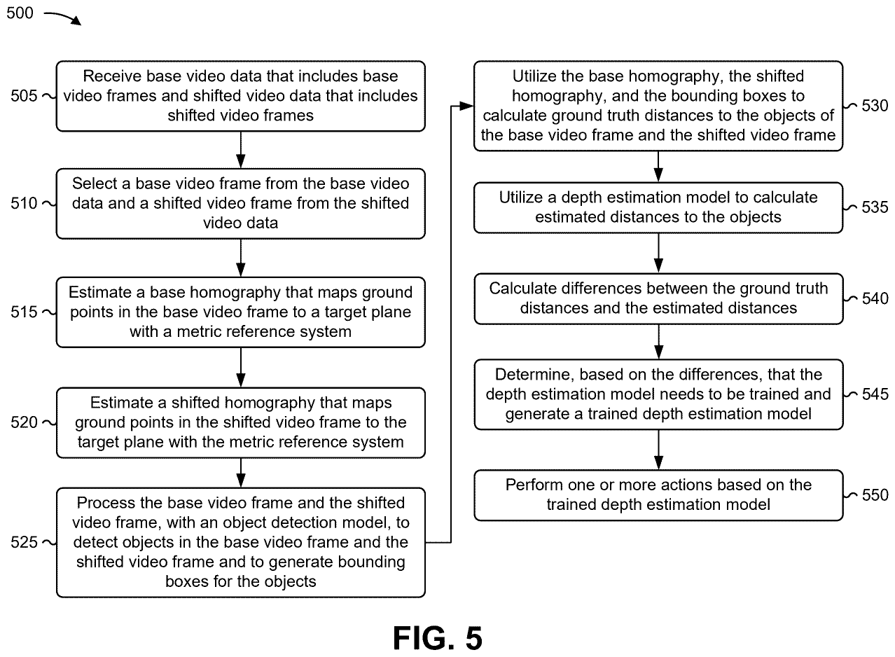

FIG. 5 depicts a flowchart of an example process 500 for performing monocular depth estimation under viewpoint shifts. In some implementations, one or more process blocks of FIG. 5 may be performed by a device (e.g., the video system 110). In some implementations, one or more process blocks of FIG. 5 may be performed by another device or a group of devices separate from or including the device, such as a control system of the vehicle, a camera (e.g., the camera 105), and/or the like. Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving base video data that includes base video frames and shifted video data that includes shifted video frames (block 505). For example, the device may receive base video data that includes base video frames and shifted video data that includes shifted video frames, as described above. In some implementations, the base video data includes road scenes captured by a base camera of a vehicle and the shifted video data includes road scenes captured by a shifted camera of the vehicle, wherein the shifted camera is moved to different positions and orientations to simulate viewpoint shifts.

As further shown in FIG. 5, process 500 may include selecting a base video frame from the base video data and a shifted video frame from the shifted video data (block 510). For example, the device may select a base video frame from the base video data and a shifted video frame from the shifted video data, as described above.

As further shown in FIG. 5, process 500 may include estimating a base homography that maps ground points in the base video frame to a target plane with a metric reference system (block 515). For example, the device may estimate a base homography that maps ground points in the base video frame to a target plane with a metric reference system, as described above. In some implementations, estimating the base homography that maps the ground points in the base video frame to the target plane with the metric reference system includes utilizing a least-squares estimation to calculate the base homography that maps the ground points in the base video frame to the target plane.

As further shown in FIG. 5, process 500 may include estimating a shifted homography that maps ground points in the shifted video frame to the target plane with the metric reference system (block 520). For example, the device may estimate a shifted homography that maps ground points in the shifted video frame to the target plane with the metric reference system, as described above. In some implementations, estimating the shifted homography that maps the ground points in the shifted video frame to the target plane with the metric reference system includes utilizing a least-squares estimation to calculate the shifted homography that maps the ground points in the shifted video frame to the target plane.

As further shown in FIG. 5, process 500 may include processing the base video frame and the shifted video frame, with an object detection model, to detect objects in the base video frame and the shifted video frame and to generate bounding boxes for the objects (block 525). For example, the device may process the base video frame and the shifted video frame, with an object detection model, to detect objects in the base video frame and the shifted video frame and to generate bounding boxes for the objects, as described above.

As further shown in FIG. 5, process 500 may include utilizing the base homography, the shifted homography, and the bounding boxes to calculate ground truth distances to the objects of the base video frame and the shifted video frame (block 530). For example, the device may utilize the base homography, the shifted homography, and the bounding boxes to calculate ground truth distances to the objects of the base video frame and the shifted video frame, as described above.

As further shown in FIG. 5, process 500 may include utilizing a depth estimation model to calculate estimated distances to the objects (block 535). For example, the device may utilize a depth estimation model to calculate estimated distances to the objects, as described above. In some implementations, the depth estimation model is a monocular depth estimation model.

As further shown in FIG. 5, process 500 may include calculating differences between the ground truth distances and the estimated distances (block 540). For example, the device may calculate differences between the ground truth distances and the estimated distances, as described above. In some implementations, the differences between the ground truth distances and the estimated distances are absolute relative errors between the ground truth distances and the estimated distances.

As further shown in FIG. 5, process 500 may include determining, based on the differences, that the depth estimation model needs to be trained and generating a trained depth estimation model (block 545). For example, the device may determine, based on the differences, that the depth estimation model needs to be trained and may generate a trained depth estimation model, as described above.

As further shown in FIG. 5, process 500 may include performing one or more actions based on the trained depth estimation model (block 550). For example, the device may perform one or more actions based on the trained depth estimation model, as described above. In some implementations, performing the one or more actions includes one or more of implementing the trained depth estimation model in a camera associated with a vehicle, implementing the trained depth estimation model in a vehicle, utilizing the trained depth estimation model to provide an alert to a vehicle, utilizing the trained depth estimation model to cause a vehicle to perform a maneuver, utilizing the trained depth estimation model to provide an alert to a fleet manager of a vehicle, or utilizing the trained depth estimation model to schedule a driver of a vehicle for training.

In some implementations, process 500 includes receiving additional video data, processing the additional video data, with the trained depth estimation model, to generate new estimated distances, and performing one or more additional actions based on the new estimated distances. In some implementations, performing the one or more additional actions based on the new estimated distances includes one or more of determining, based on the new estimated distances, that the depth estimation model needs to be retrained, providing an alert to a vehicle based on the new estimated distances, causing a vehicle to perform a maneuver based on the new estimated distances, providing an alert to a fleet manager of a vehicle based on the new estimated distances, or scheduling a driver of a vehicle for training based on the new estimated distances.

In some implementations, process 500 includes filtering out bounding boxes with a confidence level lower than a predetermined threshold prior to utilizing the base homography, the shifted homography, and the bounding boxes to calculate the ground truth distances to the objects. In some implementations, process 500 includes receiving GPS data and accelerometer data associated with the base video data and the shifted video data, and utilizing the GPS data and the accelerometer data to further train the depth estimation model. In some implementations, process 500 includes validating the base homography and the shifted homography using a dataset with validated ground truth distances. In some implementations, process 500 includes utilizing the trained depth estimation model for detecting tailgating associated with a vehicle.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, base video data that includes base video frames and shifted video data that includes shifted video frames;
selecting, by the device, a base video frame from the base video data and a shifted video frame from the shifted video data;
estimating, by the device, a base homography that maps ground points in the base video frame to a target plane with a metric reference system;
estimating, by the device, a shifted homography that maps ground points in the shifted video frame to the target plane with the metric reference system;
processing, by the device, the base video frame and the shifted video frame, with an object detection model, to detect objects in the base video frame and the shifted video frame and to generate bounding boxes for the objects;
utilizing, by the device, the base homography, the shifted homography, and the bounding boxes to calculate ground truth distances to the objects of the base video frame and the shifted video frame;
utilizing, by the device, a depth estimation model to calculate estimated distances to the objects;
calculating, by the device, differences between the ground truth distances and the estimated distances;
determining, by the device and based on the differences, that the depth estimation model needs to be trained and generating a trained depth estimation model; and
performing, by the device, one or more actions based on the trained depth estimation model.

2. The method of claim 1, further comprising:
receiving additional video data;
processing the additional video data, with the trained depth estimation model, to generate new estimated distances; and
perform one or more additional actions based on the new estimated distances.

3. The method of claim 2, wherein performing the one or more additional actions based on the new estimated distances comprises one or more of:
determining, based on the new estimated distances, that the depth estimation model needs to be retrained;
providing an alert to a vehicle based on the new estimated distances;
causing a vehicle to perform a maneuver based on the new estimated distances;
providing an alert to a fleet manager of a vehicle based on the new estimated distances; or
scheduling a driver of a vehicle for training based on the new estimated distances.

4. The method of claim 1, wherein performing the one or more actions comprises one or more of:
implementing the trained depth estimation model in a camera associated with a vehicle;
implementing the trained depth estimation model in a vehicle;
utilizing the trained depth estimation model to provide an alert to a vehicle;
utilizing the trained depth estimation model to cause a vehicle to perform a maneuver;
utilizing the trained depth estimation model to provide an alert to a fleet manager of a vehicle; or
utilizing the trained depth estimation model to schedule a driver of a vehicle for training.

5. The method of claim 1, wherein the depth estimation model is a monocular depth estimation model.

6. The method of claim 1, wherein estimating the base homography that maps the ground points in the base video frame to the target plane with the metric reference system comprises:
utilizing a least-squares estimation to calculate the base homography that maps the ground points in the base video frame to the target plane.

7. The method of claim 1, wherein estimating the shifted homography that maps the ground points in the shifted video frame to the target plane with the metric reference system comprises:
utilizing a least-squares estimation to calculate the shifted homography that maps the ground points in the shifted video frame to the target plane.

8. A device, comprising:
one or more processors configured to:
receive base video data that includes base video frames and shifted video data that includes shifted video frames;
select a base video frame from the base video data and a shifted video frame from the shifted video data;
estimate a base homography that maps ground points in the base video frame to a target plane with a metric reference system;
estimate a shifted homography that maps ground points in the shifted video frame to the target plane with the metric reference system;
process the base video frame and the shifted video frame, with an object detection model, to detect objects in the base video frame and the shifted video frame and to generate bounding boxes for the objects;
utilize the base homography, the shifted homography, and the bounding boxes to calculate ground truth distances to the objects of the base video frame and the shifted video frame;
utilize a depth estimation model to calculate estimated distances to the objects;
calculate differences between the ground truth distances and the estimated distances;
determine, based on the differences, that the depth estimation model needs to be trained and generate a trained depth estimation model;
receive additional video data;
process the additional video data, with the trained depth estimation model, to generate new estimated distances; and
perform one or more actions based on the new estimated distances.

9. The device of claim 8, wherein the one or more processors are further configured to:
filter out bounding boxes with a confidence level lower than a predetermined threshold prior to utilizing the base homography, the shifted homography, and the bounding boxes to calculate the ground truth distances to the objects.

10. The device of claim 8, wherein the differences between the ground truth distances and the estimated distances are absolute relative errors between the ground truth distances and the estimated distances.

11. The device of claim 8, wherein the base video data includes road scenes captured by a base camera of a vehicle, and the shifted video data includes road scenes captured by a shifted camera of the vehicle,
wherein the shifted camera is moved to different positions and orientations to simulate viewpoint shifts.

12. The device of claim 8, wherein the one or more processors are further configured to:
receive global positioning system (GPS) data and accelerometer data associated with the base video data and the shifted video data; and
utilize the GPS data and the accelerometer data to further train the depth estimation model.

13. The device of claim 8, wherein the one or more processors are further configured to:
validate the base homography and the shifted homography using a dataset with validated ground truth distances.

14. The device of claim 8, wherein the one or more processors are further configured to:
utilize the trained depth estimation model for detecting tailgating associated with a vehicle.

15. A non-transitory computer-readable medium storing a set of instructions, the set of instructions comprising:
one or more instructions that, when executed by one or more processors of a device, cause the device to:
receive video data that includes base video frames and shifted video frames;
select a base video frame and a shifted video frame from the video data;
estimate a base homography that maps ground points in the base video frame to a target plane with a metric reference system;
estimate a shifted homography that maps ground points in the shifted video frame to the target plane with the metric reference system;
process the base video frame and the shifted video frame, with an object detection model, to detect objects in the base video frame and the shifted video frame and to generate bounding boxes for the objects;
utilize the base homography, the shifted homography, and the bounding boxes to calculate ground truth distances to the objects of the base video frame and the shifted video frame;
utilize a depth estimation model to calculate estimated distances to the objects;
calculate differences between the ground truth distances and the estimated distances;
determine, based on the differences, the depth estimation model needs to be trained and generate a trained depth estimation model; and
perform one or more actions based on the trained depth estimation model.

16. The non-transitory computer-readable medium of claim 15, wherein the one or more instructions, that cause the device to estimate the base homography that maps the ground points in the base video frame to the target plane with the metric reference system, cause the device to:
utilize a least-squares estimation to calculate the base homography that maps the ground points in the base video frame to the target plane.

17. The non-transitory computer-readable medium of claim 15, wherein the one or more instructions, that cause the device to estimate the shifted homography that maps the ground points in the shifted video frame to the target plane with the metric reference system, cause the device to:
utilize a least-squares estimation to calculate the shifted homography that maps the ground points in the shifted video frame to the target plane.

18. The non-transitory computer-readable medium of claim 15, wherein the one or more instructions further cause the device to:
filter out bounding boxes with a confidence level lower than a predetermined threshold prior to utilizing the base homography, the shifted homography, and the bounding boxes to calculate the ground truth distances to the objects.

19. The non-transitory computer-readable medium of claim 15, wherein the one or more instructions further cause the device to:
receive global positioning system (GPS) data and accelerometer data associated with the base video data and the shifted video data; and
utilize the GPS data and the accelerometer data to further train the depth estimation model.

20. The non-transitory computer-readable medium of claim 15, wherein the one or more instructions further cause the device to:
validate the base homography and the shifted homography using a dataset with validated ground truth distances.
